(19) United States
(12) Patent Application Publication
(10) Pub. No.: US 2017/0329294 A1
(43) Pub. Date: Nov. 16, 2017

(54) METHODS FOR CONTROLLING APPLIANCES USING SCRIPTED SWITCHES AND BUTTONS

(71) Applicants: YUAN-NENG FAN, PARADISE VALLEY, AZ (US); SHIH-MING TUNG, NEW TAIPEI CITY (TW); CHIEN-MING CHEN, NEW TAIPEI CITY (TW)

(72) Inventors: YUAN-NENG FAN, PARADISE VALLEY, AZ (US); SHIH-MING TUNG, NEW TAIPEI CITY (TW); CHIEN-MING CHEN, NEW TAIPEI CITY (TW)

(21) Appl. No.: 15/663,551

(22) Filed: Jul. 28, 2017

Related U.S. Application Data
(62) Division of application No. 14/605,552, filed on Jan. 26, 2015.

(51) Int. Cl. G05B 15/02

(52) U.S. Cl. CPC G05B 15/02; G05B 2219/2642

(57) ABSTRACT

A method and system allowing for the use of traditional buttons and switches to operate sophisticated features of smart appliances when a smartphone, a tablet, or a computer is not available is provided. Wall switches with existing wiring in a building or buttons on appliances can be used when a smartphone or other remote controlling devices are not available. A normally-closed (NC) wall switch or button can be used to control a smart appliance with only a power line connection in between the NC switch and the smart appliance without a wireless connection, or additional wires to send control signals.

### TECHNICAL FIELD

The present application in general relates to smart appliances, and more specifically, to a method and system for operating features of smart appliances using wall switches with existing wiring in a building or buttons on an appliance when a remote control, computer, tablet, or smartphone is not available.

### BACKGROUND

A smart appliance is a term which may be used to describe a device, which combines conventional task specific appliance operation under the control of an embedded system or application specific operating system that may also be remotely controlled with a smart phone, tablet, or other computing device via different protocols such as Bluetooth, near field communication (NFC), WiFi, 3G, 4G, long term evolution (LTE), LTE-Advanced, mobile broadband wireless access (MBWA), other broadband standards, Ethernet, Internet, etc.

Traditional appliances may be controlled using one or more buttons or switches on the appliance, with a wall switch, or a dedicated remote control. Usually, limited programming capabilities are provided for traditional appliances. An example would be the use of a light switch mounted on wall to turn ceiling lights on or off. In contrast, some smart appliances may be managed and controlled by a smartphone or a computer through sophisticated software applications. When a user is away from home, controlling of a smart appliance may be done through the Internet over a mobile network. However, if a wall switch controlling the electrical supply to this smart appliance is turned off accidently, controlling the smart appliance is not possible from anywhere. In addition, an end user must have immediate access a smartphone to control the smart appliance, and if the smartphone or other type of remote control device is misplaced the user may not be able to access or adjust operating features of the appliance. It would thus be desirable to provide a system and method for a user to control and access features of a smart appliance when a remote control device is not available.

### SUMMARY

In accordance with one embodiment, a method uses a normally-closed (NC) wall switch to control a smart appliance with only a power line connection in between with no wireless, or additional wires to send control signals. When pressed, the NC wall switch breaks AC power connection to a smart appliance. The smart appliance detects circuit breaking and the duration of breaking, and performs operation scripts for the breaking and duration programmed in smartphones and downloaded to smart appliance

In accordance with one embodiment, a method uses a normally-closed (NC) electronic switch to send a control signal with precise timing to smart appliances. Depending on the button pressed, the NC electronic switch breaks AC power connection to a smart appliance for a predetermined number of break and make actions and their duration. The smart appliance detects circuit breaking and making and their durations, and performs operation scripts programmed in smartphones for the specific number of breaking, making and their durations.

In accordance with one embodiment, a method uses a smart master switch to measure breaking and duration of breaking by other NC switches, and performs operation scripts programmed in smartphones and downloaded for the breaking and duration.

In accordance with one embodiment, a method uses a smart switch to measure on and off status of a multiple-way switch system. All but one of switches in the system are traditional 3 and 4-way switches. It performs operation scripts programmed in smartphones and downloaded for the breaking and duration. Regardless of status of each switch in the system, smartphones can receive status and control power to the appliance directly or remotely through mobile network.

In accordance with one embodiment, a method uses an intelligent remote control unit that is also discoverable when searching from a smartphone or from one of devices it controls. When this intelligent remote control unit is out of wireless range of a smartphone, an alarm is enabled to remind users

### BRIEF DESCRIPTION OF THE DRAWINGS

The present application is further detailed with respect to the following drawings. These figures are not intended to limit the scope of the present application but rather illustrate certain attributes thereof.

FIG. 1A is a schematic of a smart appliance controller using three Normally-Closed (NC) switches with a smart controller for two groups of ceiling lights and one fan according to one aspect of the present application;

FIG. 1B is an exemplary flowchart depicting an operational sequence for the smart appliance controller depicted in FIG. 1A according to one aspect of the present application.

FIG. 2 is a schematic of a smart switch for two groups of ceiling lights and one fan according to one aspect of the present application;

FIG. 3A is a schematic of a smart 5-way switch system using a smart master switch and three NC switches to control non-smart ceiling lights according to one aspect of the present application;

FIG. 3B is an exemplary flowchart depicting an operational sequence for the smart master switch for the master switches depicted in FIGS. 2 and 3A according to one aspect of the present application;

FIG. 3C is an exemplary flowchart depicting an operational sequence for the smart master dimmer for the master switches depicted in FIGS. 2 and 3A according to one aspect of the present application;

FIG. 4 is an operational schematic of a traditional 4-way switch.

FIG. 5A is a schematic of an implementation of a smart 3-way switch to upgrade an existing 4 way switch system according to one aspect of the present application;

FIG. 5B is an exemplary flowchart depicting an operational sequence for the smart 3-way switch depicted in FIG. 5A according to one aspect of the present application;

FIG. 6 is a schematic of an implementation of a smart 3-way switch utilizing a diode network for power measurement according to one aspect of the present application;

FIG. 7 is a schematic of an implementation of a smart 3-way switch utilizing a diode network for power measurement according to one aspect of the present application;

FIG. 8 is a schematic of an implementation of a smart 3-way switch utilizing a transformer for power measurement according to one aspect of the present application;

FIG. 9 is a schematic of an implementation of a smart 3-way switch utilizing a transistor for power measurement according to one aspect of the present application;

FIG. 10 is a state table showing the use of one switch to turn on one group of lights, to dim a second group of lights with 3-level dimming and to control speed of a fan according to one aspect of the present application;

FIG. 11 is a state table showing the use of one switch to turn on one group of lights, to dim a second group of lights with 6-level dimming and to control speed of a fan according to one aspect of the present application;

FIG. 12 is a state table showing the use 4 bits to generate sixteen control scripts generated with three buttons to control buttons to control two groups of lights and one ceiling fan according to one aspect of the present application;

FIG. 13 is a state table for 3-level dimming of a light with one intensity level set at 10% in additional to an ON/OFF light switch according to one aspect of the present application;

FIG. 14 is a state table for 4-level dimming of a light with two intensity levels set at 30% and 10% in addition to an ON/OFF light switch according to one aspect of the present application;

FIG. 15 is a state table for 4-level dimming of a light with eight intensity levels set at 80%, 60%, 40%, 30%, 20, and 10% in addition to an ON/OFF light switch according to one aspect of the present application; and

FIG. 16 is a flowchart for an intelligent remote control unit according to one aspect of the present application.

### DESCRIPTION OF THE APPLICATIONS

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure

In this application, a smartphone may be a smartphone, a tablet, a computer, or other remote control device. With the use of software applications, sophisticated operation scripts for a smart appliance may be developed and downloaded.

As used herein, a smart appliance is an appliance with at least a built in processor that communicates with smartphones by wire (for example, Ethernet, USB) or wireless (for example, WiFi, Bluetooth, Zigbee, or proprietary) methods. A smart appliance may be a light bulb, a ceiling fan, ceiling lights, a lamp, a building lighting system, an HVAC (Heating, Ventilation, Air Conditioning) system, a security system, a refrigerator, a washer, a dryer, a television, a home theater system, or any other application specific device that has controllable functions.

As used herein, a smart switch may be a wall switch with one or more buttons in a home or a commercial building that may instruct a smart appliance to perform operation scripts that control the actions or outputs of the appliance. A smart master switch may have one or more buttons, and works with a number of normally-closed (NC) switches in a multiple location installation. A smart master switch may control smart or non-smart appliances. A smart 3-way switch with one or more buttons, may replace one of traditional 3-way switch in a 3, 4, or more way switch system, and may measure on and off status of a multiple-way switch system. A smart 3-way switch may receive instructions from a smartphone and may report status of a switch system to smartphones. A smart button is one or more buttons on a smart appliance, or on a control panel connected to smart appliance with wires or wirelessly. When a smart button is pressed, the smart appliance performs corresponding operation scripts.

Embodiments of the exemplary method and system allow for the use of traditional buttons and switches to operate sophisticated features of smart appliances when a smartphone, a tablet, or a computer is not available. Embodiments of the invention may use typical wall switches with existing wiring in the building or buttons on appliances when a smartphone or other remote controlling devices are not available. As used herein a typical wall switch may refer to a switch for an appliance, e.g., ceiling lights, fan, or table lamp, that may be toggled between on (make) and off (break) position. The appliance can be either powered on or powered off.

In an inventive embodiment, a normally-closed (NC) wall switch or button may be used to control a smart appliance with only a power line connection in between the NC switch and the smart appliance without a wireless connection, or additional wires to send control signals. It is noted that in most existing homes and commercial buildings, no wire is available to send control signals from a light switch to ceiling lights. A NC switch is biased to a closed position by a spring or clip, where the spring or clip forces the contact to a closed position when a user releases pressure. When the NC switch or button is pressed or actuated in an inventive embodiment, an AC power connection to a smart appliance is broken (break state), and a smart appliance detects the circuit breaking and the duration of the breaking, and in response the appliance performs operation scripts for the breaking and duration that are programmed in smartphones, as well as other controlling devices, and downloaded to the smart appliance.

In an inventive embodiment, a normally-closed electronic switch may send control signals with precise timing to smart appliances. Depending on the button pressed, an AC power connection to a smart appliance is broken for a predetermined number of break and make actions with a corresponding duration. The smart appliance detects the circuit breaking and making and their durations, and in response performs operation scripts programmed in smartphones for the specific number of breaking, making and their durations.

In an inventive embodiment, a smart master switch may be used to measure breaking and duration of breaking by other NC switches. The smart appliance may perform operation scripts programmed in smartphones and downloaded for the breaking and duration. Using ceiling lights as an example, by pressing one switch, smart master switch can turn lights on, off or dim light.

In an inventive embodiment, a smart switch may be used to measure on and off status of a multiple-way switch system, where all but one of switches in the system are traditional 3 and 4-way switches. The smart appliance may perform operation scripts programmed in smartphones or other computing devices, which may be downloaded for the breaking and duration. Regardless of the make or break status of each switch in the system, smartphones or other controlling devices can receive status and control power to the appliance directly or remotely through a mobile network and home gateway.

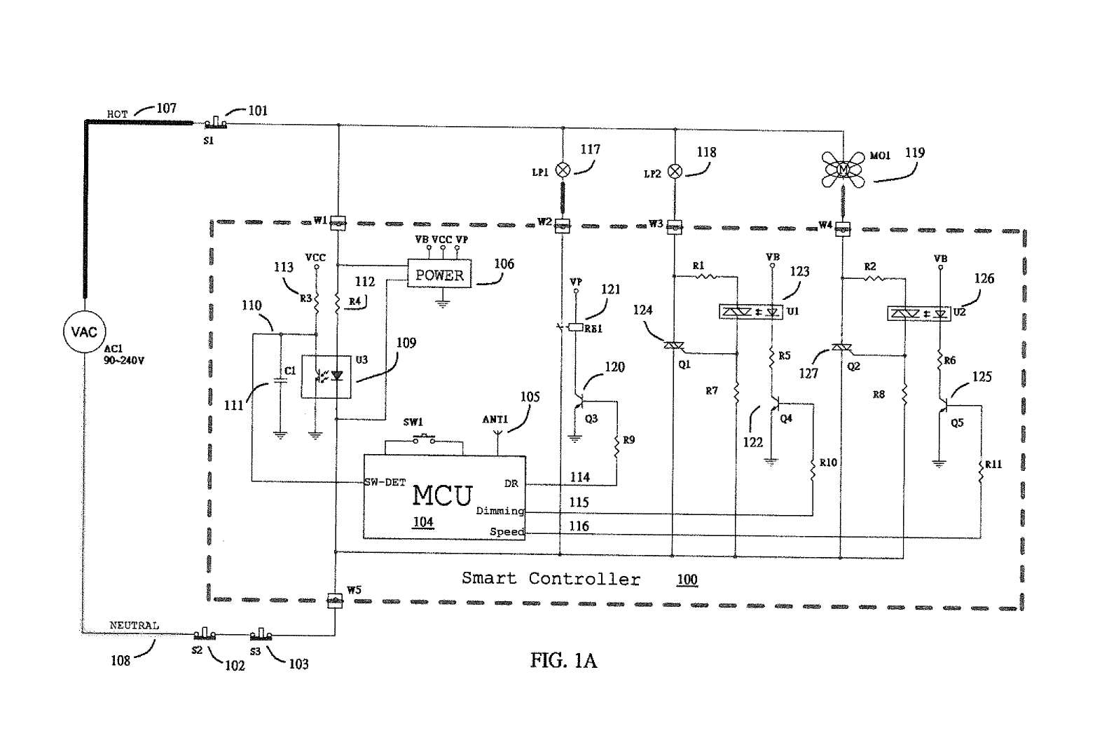

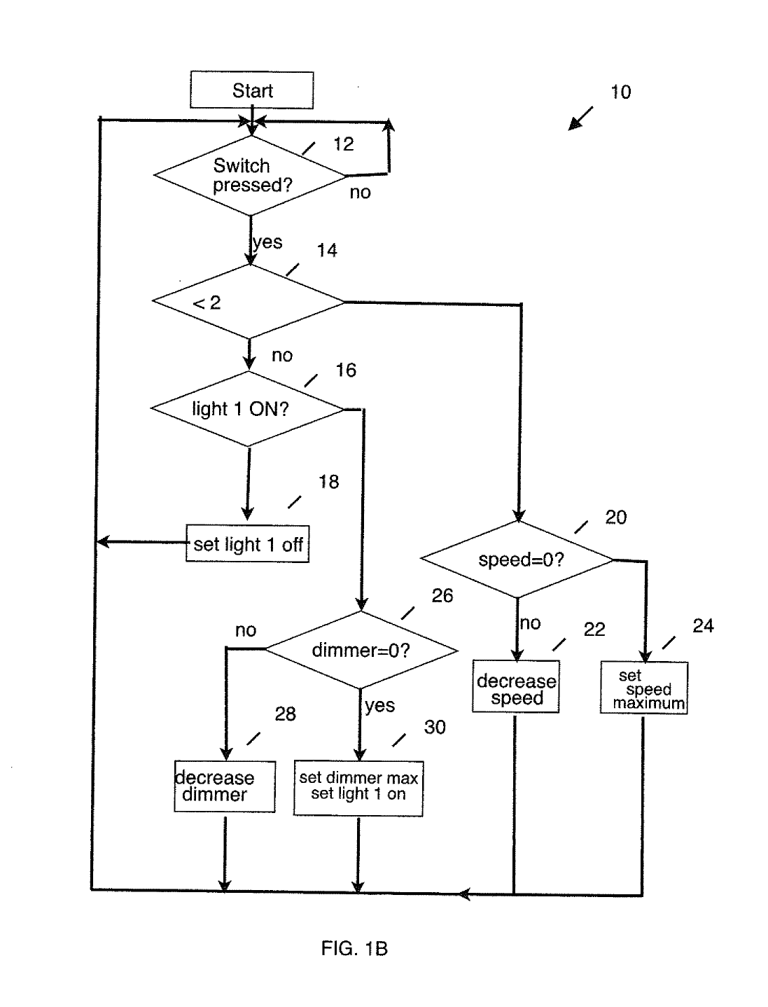

In the inventive embodiments described in the following figures, ceiling lights and fans are used as non-limiting examples of smart appliances. Referring now to FIG. 1A, a smart controller (SC) 100 in ceiling lights detects circuit breaking and duration of the breaking by normally-closed (NC) switches S1 (101), S2 (202), or S3 (103). SC 100, where the three NCs form a 4-way switch system. The master control unit (MCU) 104 in the smart controller 100 has an antenna 105 for facilitating communication with smartphones wirelessly. In a specific embodiment, scripts (program instruction) that have been developed in smartphones may be downloaded into the smart controller 100 by wireless means and stored in memory in the MCU 104. The memory may be program memories and/or data memories. Power supply 106 is connected to hot wire 107 and neutral wire 108 to generate voltages for the smart controller 100. Optical coupler U2 (109) is also connected to hot wire 107 and neutral wire 108. Resistor R2 (112) limits electrical current and protects the LED inside optical coupler 109. Output 110 is low when none of NC switches 101, 102, 103 is pressed. Capacitor C1 (111) and resistor R3 (113) are used to filter out high frequency noise for MCU 104 to measure AC power breaking events and their duration. MCU 104 has three output signals DR 114, dimming 115, and speed 116 to control lights 117, lights 118, and fan 119, respectively. Output 114 controls transistor Q3 (120) and relay 121 to turn lights 117 on or off. Output 115 drives transistor Q4 (122), zero crossing optical isolator U1 (123), and triac Q1 (124) to vary (increase/decrease) alternating current voltage supplied to lights 118. Light intensity varies with alternating current voltage supplied. A second set of transistors Q5 (125), zero crossing optical isolator U2 (126), and triac Q2 (127) are configured to vary alternating current voltage to control the speed of fan 119.

The scripts used in embodiments of the inventive control circuits may be developed with a smartphone using software applications (apps) or with a computing device and various software programs configured with a graphical user interface (GUI) for setting up smart appliance scripts or programs for downloading to the smart appliance. The scripts may be downloaded into the MCU 104 by wireless or wired connections. The MCU 104 executes these scripts per the instructions from one of the NC switches, smartphone, or buttons on the smart master switch.

In a specific embodiment of the inventive control scripts two types of normally-closed (NC) switch state durations for pressing an NC switch are defined as follows:
1. Short press: 2 seconds or less of NC switch pressing.
2. Long press: 2 seconds or more of NC switch pressing.

It is noted that differing NC switch intervals may be defined and operative with embodiments of the invention.

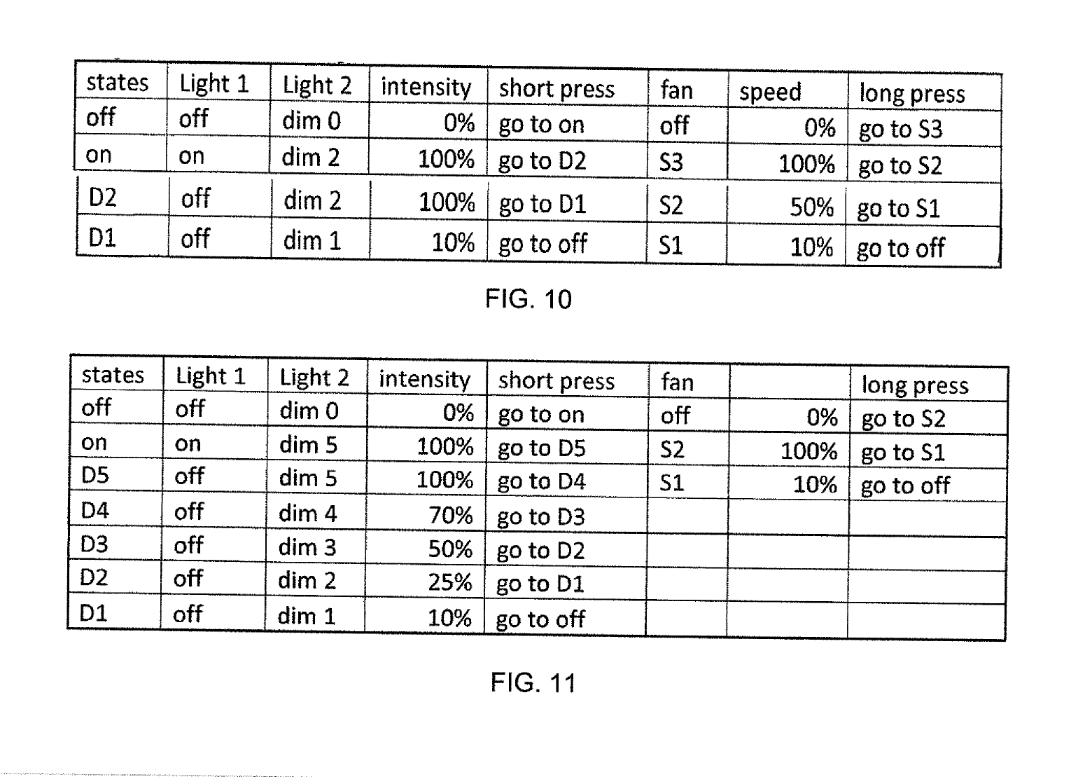

The state table of FIG. 10 shows the use of a single NC switch to turn on one group of lights, to dim a second group of lights with 3-level dimming and to control speed of a fan such as with the configuration shown in FIG. 1A. For two groups lights, one switch with one type of key press is enough to switch one and to dim the second. If there is only one group of lights or only one fan, scripts can be further simplified. As shown in FIG. 10, the lights 1 and 2 as well as the fan are all initially off. A short press of the NC switch or button causes light 1 and light 2 to turn on with light 2 at 100% intensity. A longer press (greater than 2 seconds) also turns the fan on at full speed (S3). In this operating state, a second short press of the NC switch or button causes light 1 to turn off and light 2 remains at 100% intensity. A longer press of the NC switch lowers the speed (S2) of the fan to 50%. A further short press of the NC switch lowers or dims the intensity of light 2 to 10% intensity, while a longer press of the NC switch also lowers the fan speed (S1) to 10%. Finally another short press of the NC switch turns the second light off, while a longer press of the NC switch also turns the fan off, and lights 1 and 2 as well as the fan are in their initial state. In a similar manner FIG. 11 illustrates the states and operation of the use of one NC switch or button to turn on one group of lights, to dim a second group of lights with 6-level dimming and to control the speed of a fan. For two groups of lights, one switch with one type of key press is enough to switch one and to dim the second.

FIG. 1B is an exemplary flowchart 10 depicting an operational sequence for the smart appliance controller depicted in FIG. 1A. If a switch is pressed (Decision block 12 is Yes) for less than two seconds (Decision block 14 is No) and light 1 is on (Decision block 16 is Yes) then light 1 is turned off. (Block 18). If the light is off (Decision block 16 is No) and the dimmer is at zero intensity (Decision block 26 is Yes) and the dimmer is set to maximum and the light is set on (Block 30), or if the dimmer is not at zero intensity (Decision block 26 is No) and the dimmer is decreased (Block 28). If the switch is pressed (Decision block 12 is Yes) for more than two seconds (Decision block 14 is Yes) and the fan is not revolving (has a speed=0) (Decision block 20 is Yes) the fan is set to maximum speed (Block 24). If the fan is revolving (has a speed greater than zero) (Decision block 20 is No) then the fan speed is decreased (Block 22).

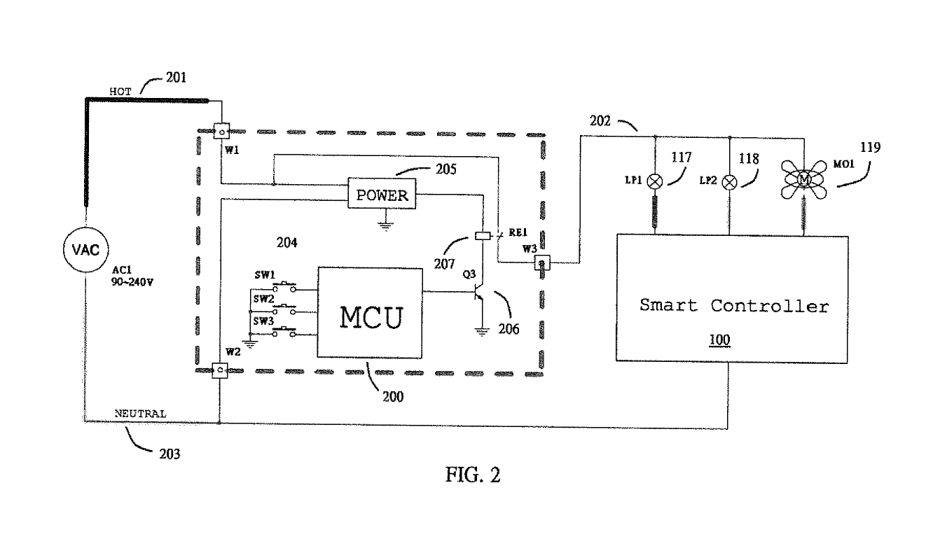

For more sophisticated operation scripts, a master control unit (MCU) controlled electronic switch is required to send precise make and break timing signals of a specific durations to a smart appliance. Schematics of an exemplary smart switch are shown in FIG. 2 with the same ceiling lights with two groups of lights and one ceiling fan as the example of FIG. 1. As shown in FIG. 2 smart switch as MCU 200 is connected to smart controller 100 through a switched hot wire 201, 202 and a neutral wire 203. MCU 200 accepts button pressing signals from buttons SW1, SW2, or SW3 (204). Each one of buttons SW1, SW2, and SW3 controls either a group of lights or a fan through the pair of switched hot wire (201, 202) and neutral wire 203. MCU 200 drives transistor Q3 (206) to open or close relay 207. With precise timing by MCU 200, relay 207 may make or break the connection for the hot wire precisely, and more control instructions may be sent to the smart controller 100.

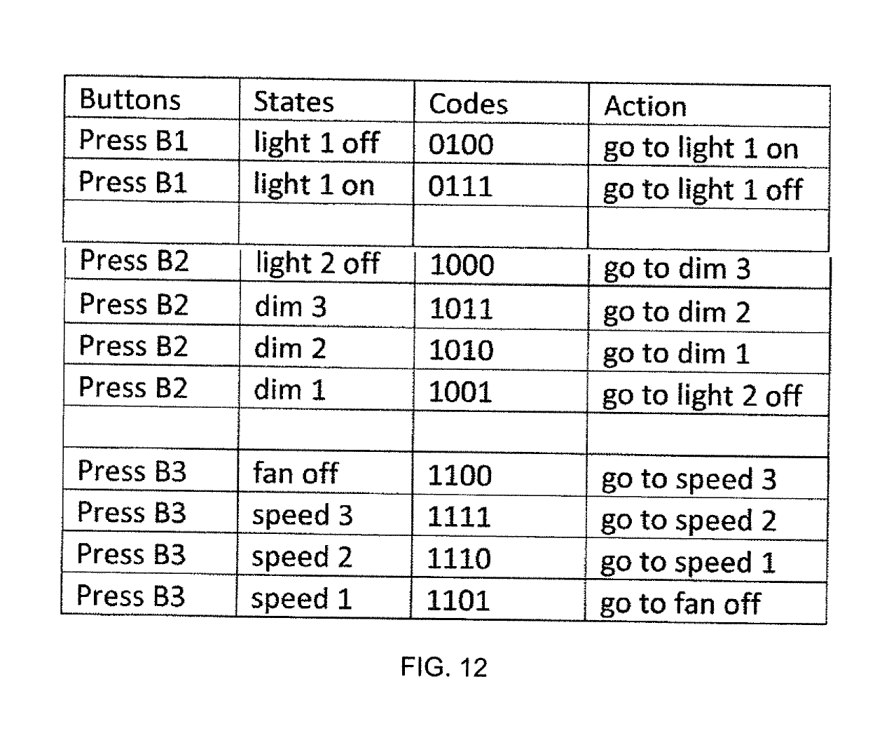

In an exemplary embodiment employing the configuration of FIG. 2, if a command bit is defined as 0.2 second of break or make, with a starting bit of break (0), 4 bits may be sent to smart appliance in 1 second as a command bit stream, and up to sixteen scripts or command combinations may be defined, “0” for break and “1” for make. An example of ten scripts generated for a smart switch with 3 buttons to control 2 groups of lights and one ceiling fan is shown in the state table of FIG. 12, where the pressing of buttons (B1, B2, B3) generate the 4 bit codes that define the scripts that control the light intensity (level of diming) and fan speed.

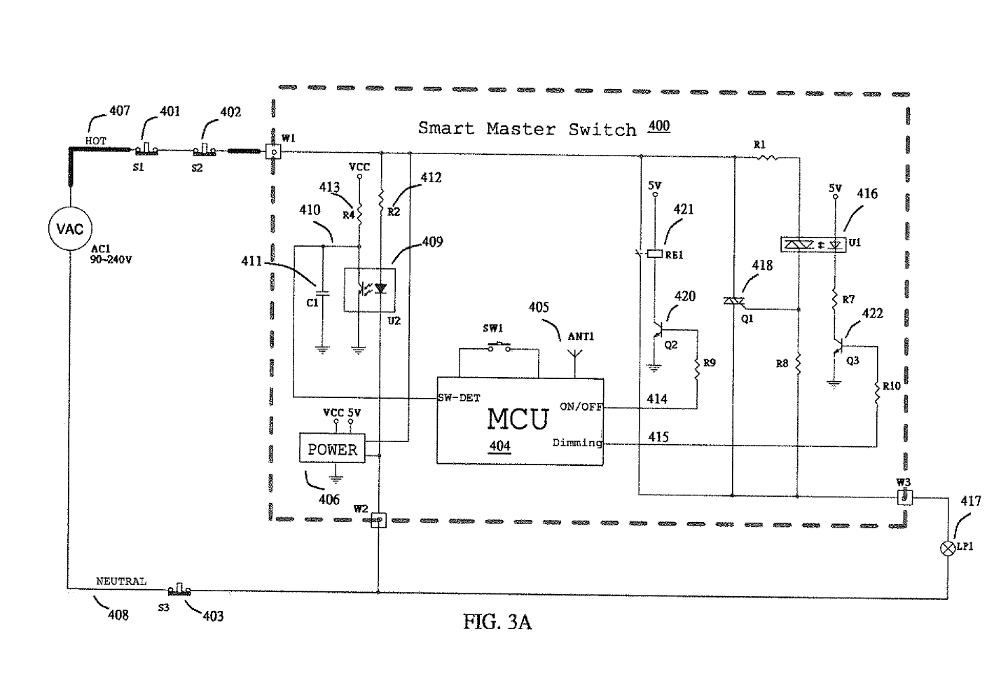

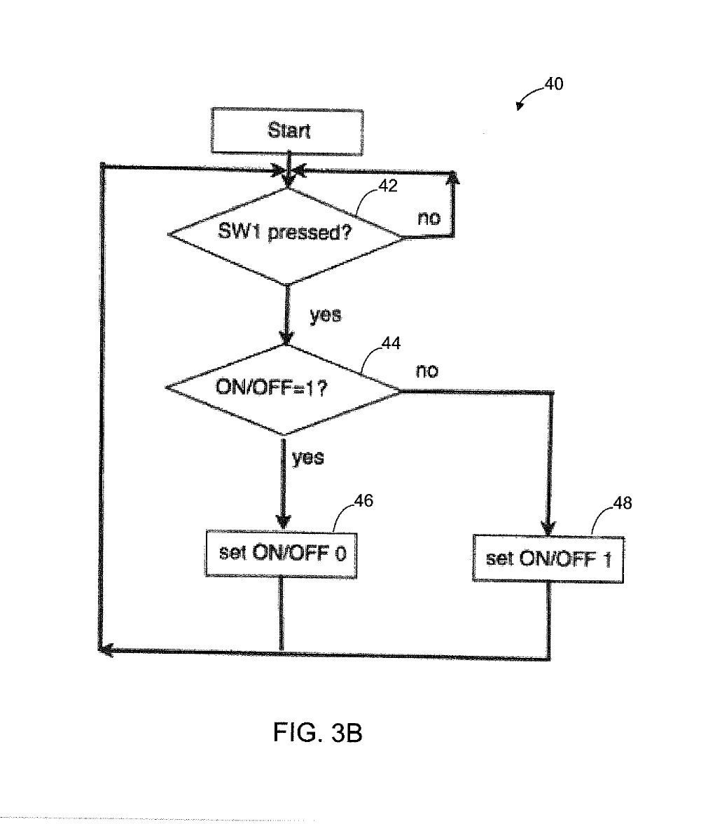

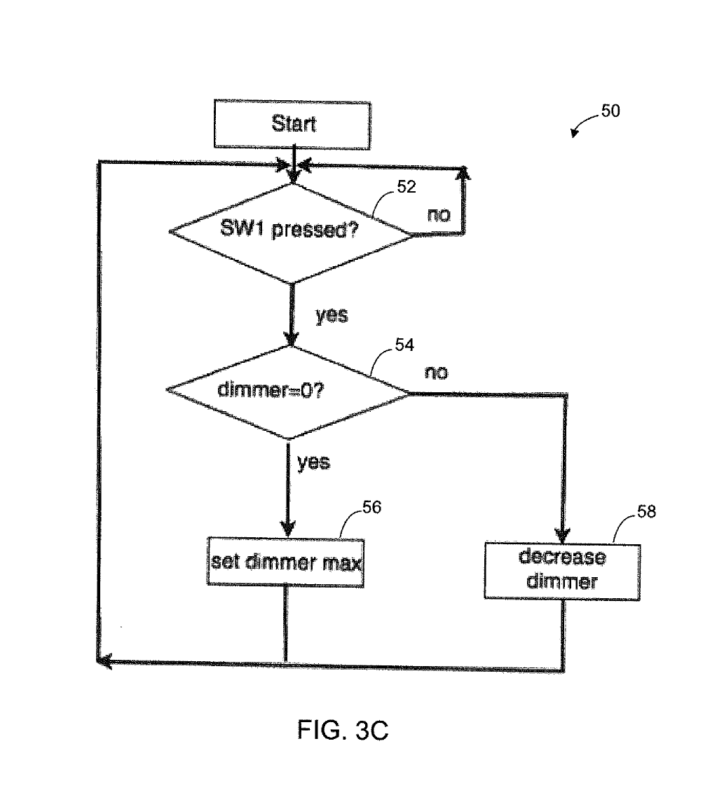

FIG. 3A shows a multiple-way smart switch configured with one smart master switch 400 and one or more NC switches (401, 402, 403) for controlling a non-smart appliance. Smart master switch 400 turns on, off, or dims light intensity by reducing voltage to the non-smart appliance. Smart master switch 400 detects the durations of the makes and breaks that are generated with the NC switches and performs per the corresponding scripts of the bit stream. The normally-closed (NC) switches S1 (401), S2 (402), or S3 (403) and smart controller (smart master switch) (SC) 400 form a 5-way switch system. The detection circuitry is the same as that in the controller. The MCU 404 in Smart Master 400 has an antenna 405 that may communicate with smartphones, computers, and other control devices wirelessly. Scripts developed in smart phones are downloaded into smart controller 400. Smartphones operation instructions may be sent to smart controller 400 by wireless means. Power supply 406 is connected to hot wire 407 and neutral wire 408 to generate voltages for smart controller 400. Optical coupler U2 (409) is also connected to hot wire 407 and neutral wire 408. Resistor R2 (412) limits electrical current and protects the LED inside Optical coupler 409. Output 410 is low when none of NC switches 401, 402, 403 is pressed. Capacitor C1 (411) and resistor R4 (413) are used to filter out high frequency noise for MCU 404 to measure AC power breaking events and their durations. MCU 404 has two output signals ON/OFF 414 and Dimming 415. Circuitry associated with ON/OFF output 414 is used in Smart master switch. Circuitry associated with dimming output 415 is used to smart master dimmer switch. Output 414 controls transistor Q2 (420) and relay 421 to connect or disconnect power to light 417. Output 415 drives transistor Q3 (422), zero crossing optical isolator U1 (416), and triac Q1 (418) to vary alternating current (AC) voltage supplying to lights 417. Light intensity varies with the alternating current (AC) voltage supplied.

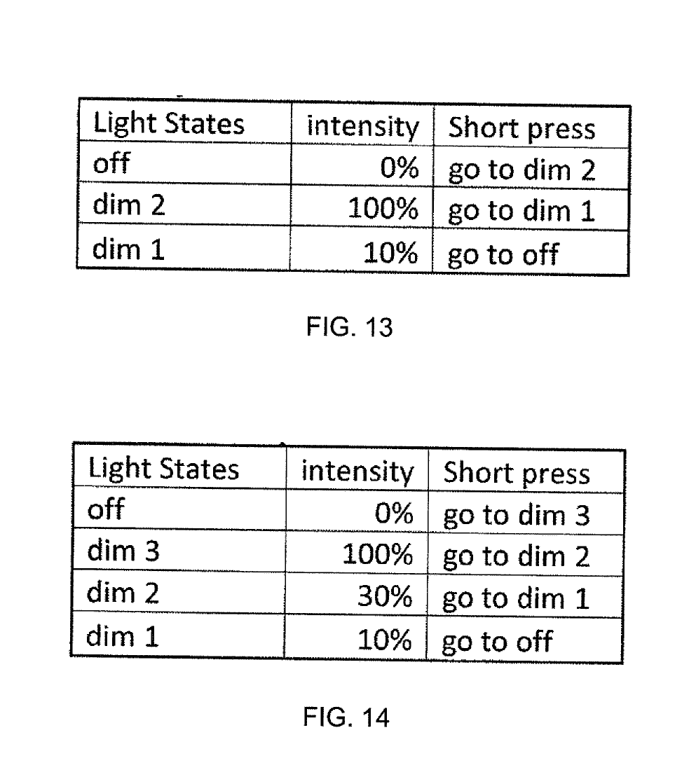

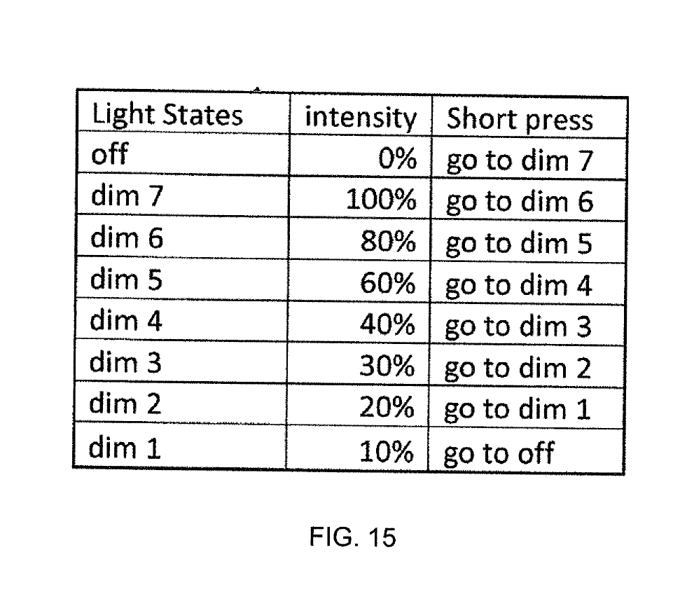

The state table shown in FIG. 13 illustrates scripts for the circuit configuration of FIG. 3A for 3-level dimming of the light 417, and has only one intensity level 10% in additional to an ON/OFF light switch. The state table shown in FIG. 14 illustrates scripts for the circuit configuration of FIG. 3A for 4-level dimming of the light 417. The state table shown in FIG. 13 illustrates scripts for the circuit configuration of FIG. 3A for traditional 8-level dimming of the light 417. In embodiments the number of dimming levels and the corresponding light intensity of each level may be programmed in smart phones or other computing devices and downloaded into smart switch 400 by wireless transmission in accordance with user preferences.

FIG. 3B is an exemplary flowchart 40 depicting an operational sequence for the smart master switch for the master switches depicted in FIGS. 2 and 3A. If switch SW1 is pressed (Decision block 42 is Yes) and the appliance is on (Decision block 44 is Yes) the appliance is turned off (Block 46). If switch SW1 is pressed (Decision block 42 is Yes) and the appliance is off (Decision block 44 is No) the appliance is turned on (Block 48).

FIG. 3C is an exemplary flowchart 50 depicting an operational sequence for the smart master dimmer for the master switches depicted in FIGS. 2 and 3A. If switch SW1 is pressed (Decision block 52 is Yes) and the dimmer is set to off (Decision block 54 is Yes) the dimmer is set to maximum (Block 56). If switch SW1 is pressed (Decision block 42 is Yes) and the dimmer is on (Decision block 54 is No) the dimmer is decreased (Block 58).

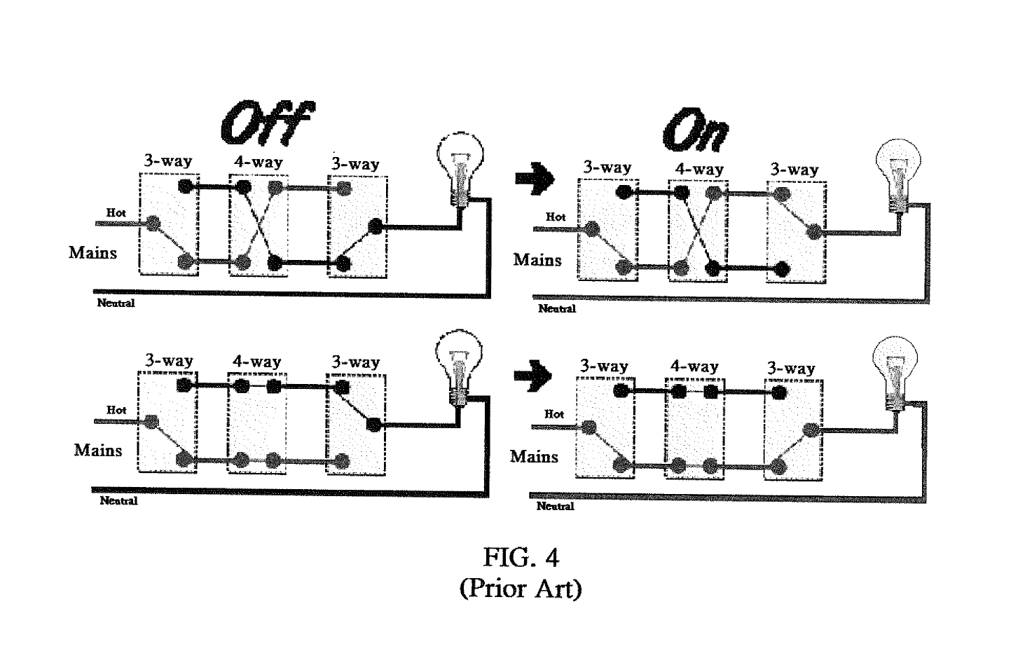

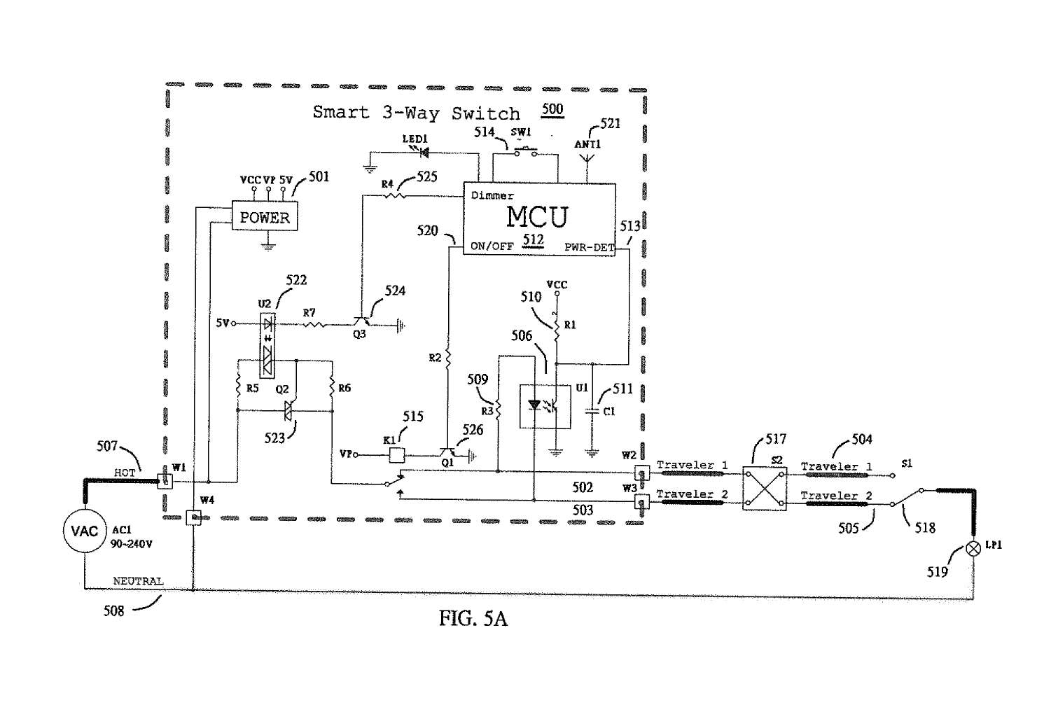

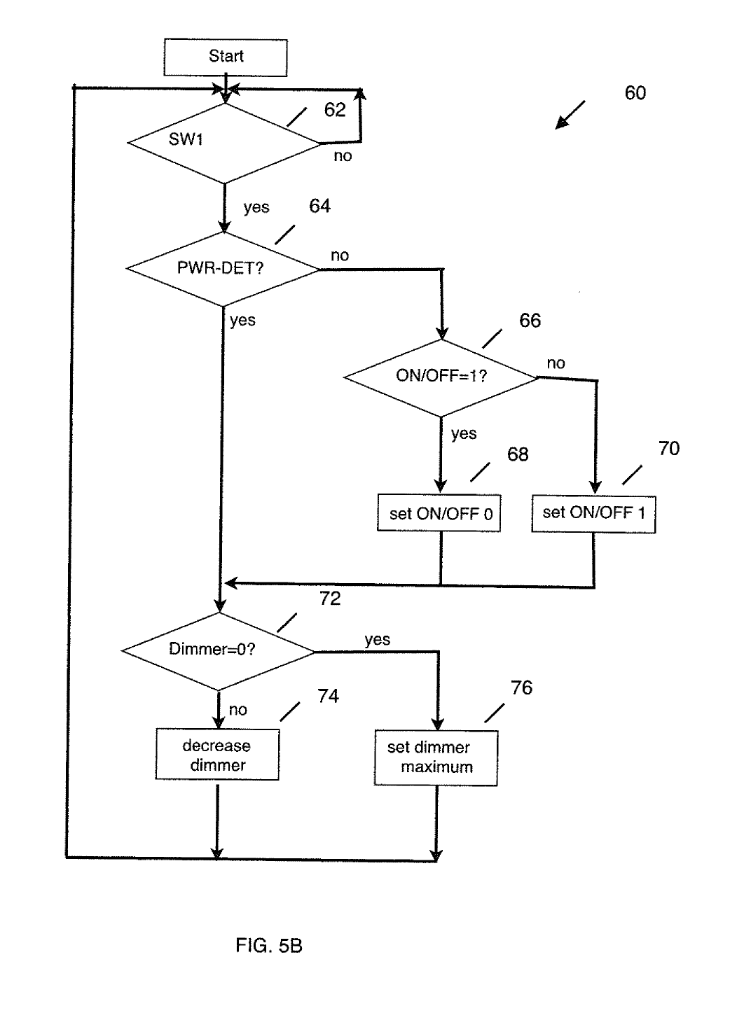

FIG. 5A is a schematic of an implementation of a smart 3-way switch to upgrade an existing 4 way switch system that is configured with two three-way switches, one four-way switch, and one load (light). The three-way switch is a single pole double throw (SPDT) switch. The four-way switch is a double pole double throw (DPDT) switch. FIG. 4 shows an operational schematic of a traditional 4-way switch in off and on states. By replacing one of the three-way switches with a smart 3-way switch 500, a three-way, four-way or more way system may become a smart switch system controllable by smart phones or other computer and remote control devices.

In FIG. 5A, power supply 501 is connected to hot wire 507 and neutral wire 508. An optical coupler 506 is connected between the traveler wire one 502 and traveler wire two 503 in the smart 3-way switch 500. Resistor R3 (509) limits current and protects the LED in optical coupler 506. Resistor R1 (510) and capacitor C1 (511) filters high frequency noise for MCU 512 input power detector (PWR-DET) 513. MCU 512 accepts scripts from a smartphone or other computer through wireless antenna 521. MCU 512 output 520 controls a transistor 516 that can switch relay K1 (515) to either output. Relay 515 is a single pole double throw (SPDT). Hot input 507 is connected to either output 1 traveler wire one 502 or output 2 traveler wire two 503. Depending on the position of 4-way switch S2 (517) and 3-way switch S1 (518), power may or may not be applied to light 519. This architecture is the same as that of a traditional 4-way switch except one of three-way switches is replaced by a smart 3-way switch. Powering condition for light 519 may be altered by flipping one of switches or the SPDT relay 515 in smart 3-way switch.

Continuing with FIG. SA, AC power from hot wire 507 is connected to traveler wire one 504 and to traveler wire two 505 through 4-way switch 517, and is connected to light 519 through 3-way switch 518 and light 519 is on. If the position at one of switches is flipped, light 519 will be off, and traveler wire two 503 is disconnected from hot wire 507, and this configuration leaves the circuit floating or not connected to any power source or power sink. There is no current going through resistor 508 or the LED inside optical isolator 506. PWR-DET 513 input to MCU 512 is high. If the 3-way switch S1 (518) is flipped, Hot wire 507 is not connected to light 519 and light 519 is OFF. Alternating current voltage between hot wire 507 and neutral wire 508 is applied across traveler wire one 502 and traveler wire two 503, and causing current to flow through resistor 509 and the LED inside optical isolator 506 with the output of optical isolator 506 is low. By measuring voltage at PWR-DET input 513, MCU 512 can determine that light 519 is now OFF. This information may be reported to a smartphone directly, or to a bridge connected to a Wi-Fi router. The information may then be reported to other smartphones without compatible wireless connections. The information may also be reported to smartphones connected to mobile Internet through this Wi-Fi router.

When button SW1 514 is pressed, MCU ON/OFF output 520 goes from high to low. It drives transistor Q1 (526) and then relay K1 (515). Relay K1 switches connection from traveler one wire 502 to traveler two wire 503. Alternating current power to light 519 is now ON. No current is flowing through resistor 509 and the LED inside optical isolator 506. Output of optical isolator 506 is high. By measuring voltage at PWR-DET input 513, MCU 512 may determine light 519 is now ON. Pressing the button on the smart 3-way switch is effectively the same as flipping switch on the traditional one. To dim light 519, MCU 512 measures power status. If light 519 is OFF, change the state of output 520 to turn the light 519 ON. Dimmer output 525 controls transistor Q3 (524), optical isolator U2 (522), and triac Q2 (523) to reduce alternating current voltage through relay 515, switches 517 and 518 to light 519. Smartphones or other computing devices may remotely access the status of lights at home or away when mobile internet is available Smartphones or other computing devices may send instructions to change status of the light 519 or download scripts for operation.

FIG. 5B is an exemplary flowchart 60 depicting an operational sequence for the smart 3-way switch depicted in FIG. 5A. If switch SW1 is pressed (Decision block 62 is Yes) and power is not detected by the MCU 512 (Decision block 64 is No) the light is turned off (Decision block 66 is No), the light is turned on (Block 70). If the light is on (Decision block 66 is Yes) the light is turned off (Block 68). If switch SW1 is pressed (Decision block 62 is Yes) and power is detected by the MCU 512 (Decision block 64 is Yes) and the dimmer is set to minimum intensity (Decision block 72 is Yes) then the dimmer is set to maximum intensity (Block 76). If the dimmer is set to an intensity level (Decision block 72 is No) then the dimmer intensity is decreased (Block 76).

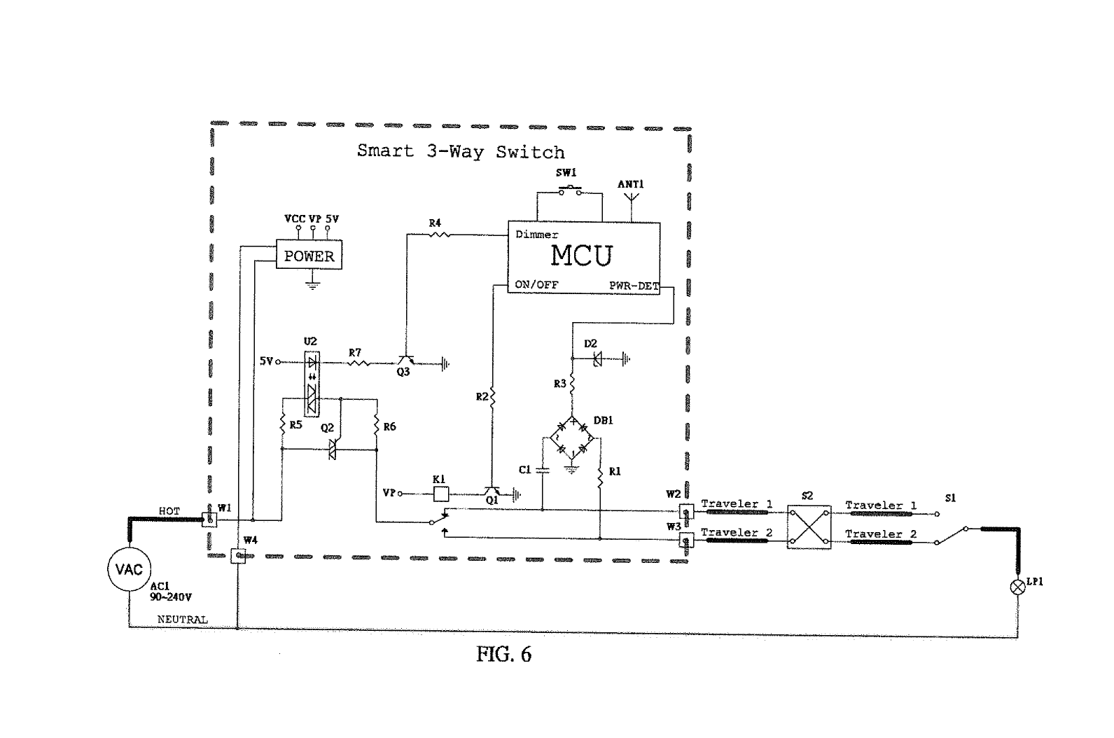

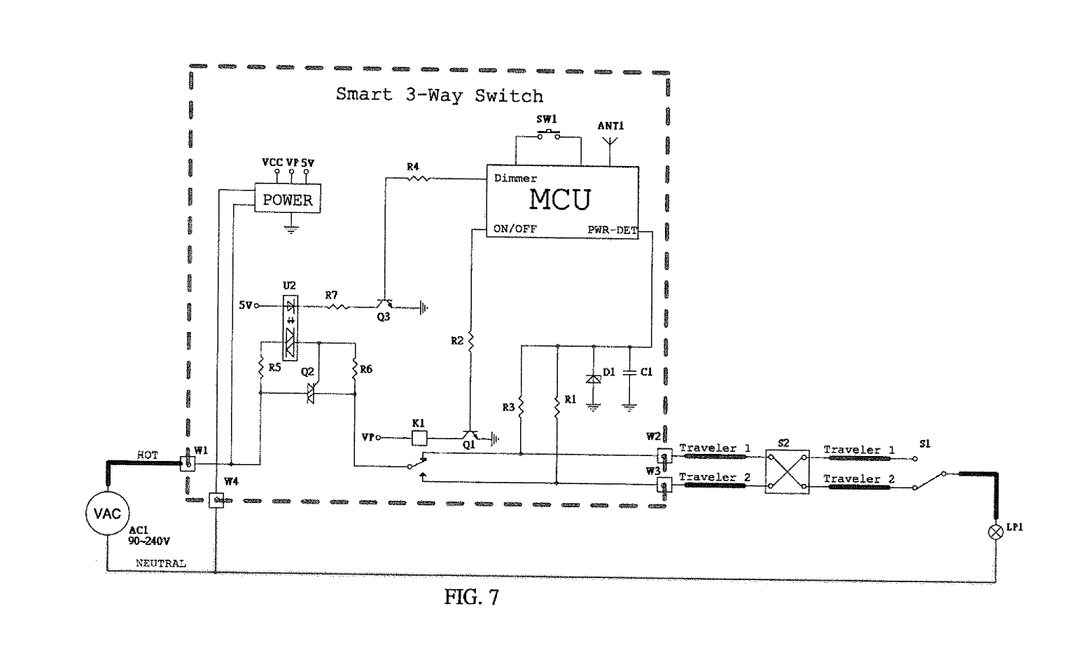

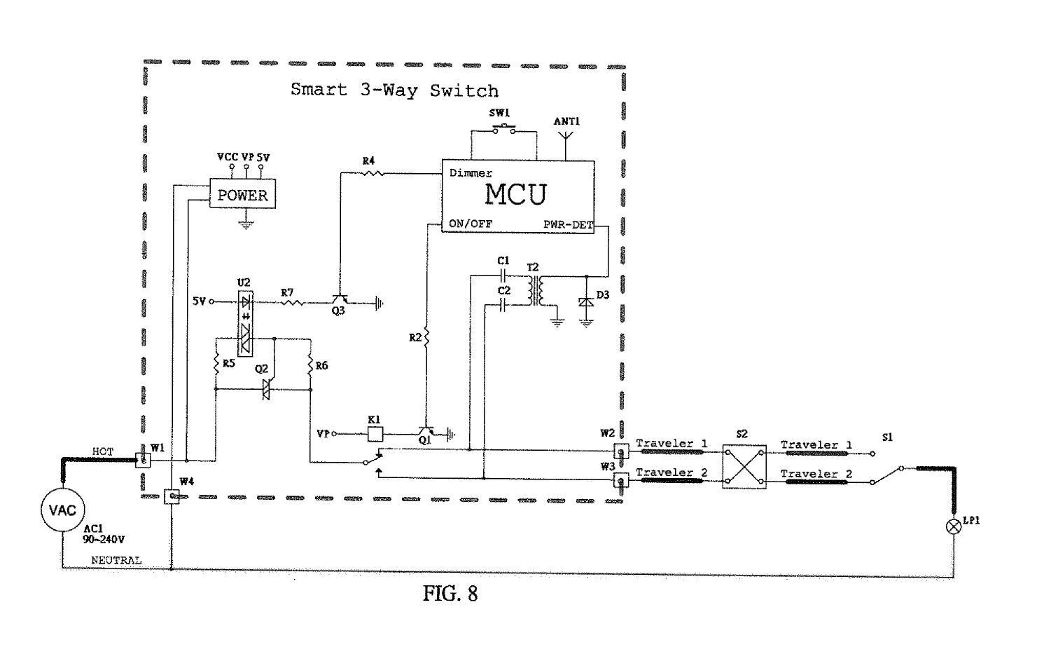

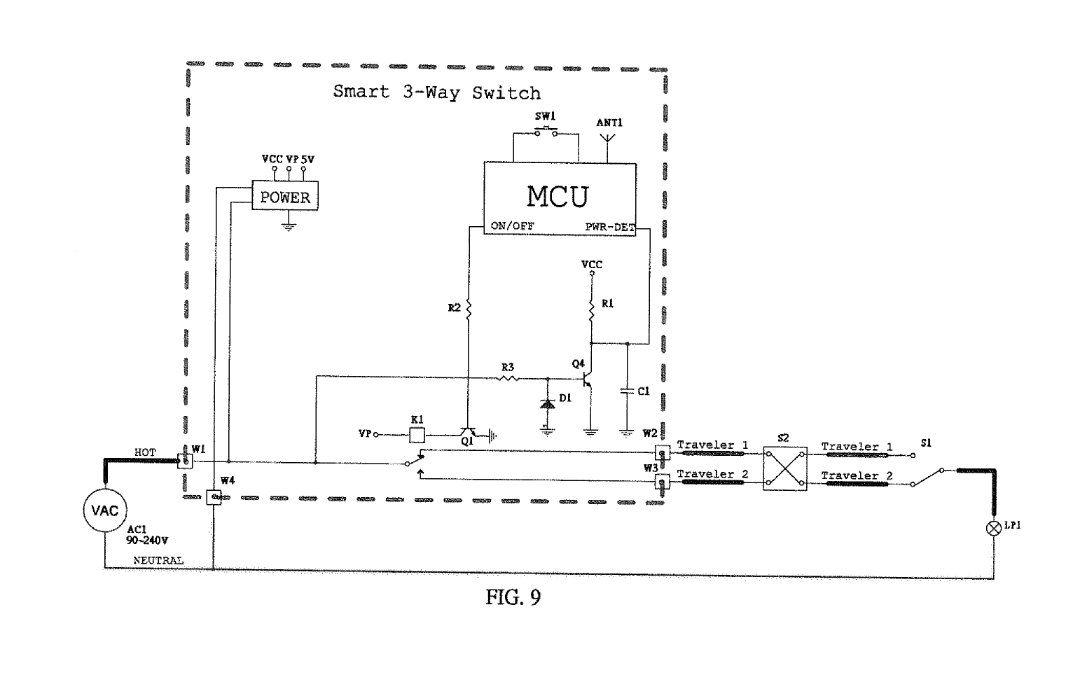

Alternative configurations for measuring alternating current power status are available for the circuit configurations described above including for traditional multiple-way switch systems, the new smart switch with normally closed switches, or a normally closed switch with smart appliances. FIG. 6 is a schematic of an implementation of a smart 3-way switch utilizing a diode network for power measurement status. FIG. 7 is a schematic of an implementation of a smart 3-way switch utilizing a resistor divider network with a zener diode for power measurement status. FIG. 8 is a schematic of an implementation of a smart 3-way switch utilizing a transformer for measurement power status. FIG. 9 is a schematic of an implementation of a smart 3-way switch utilizing a transistor for power measurement status. The same circuits may be used in measuring alternating current making, breaking, and their duration.

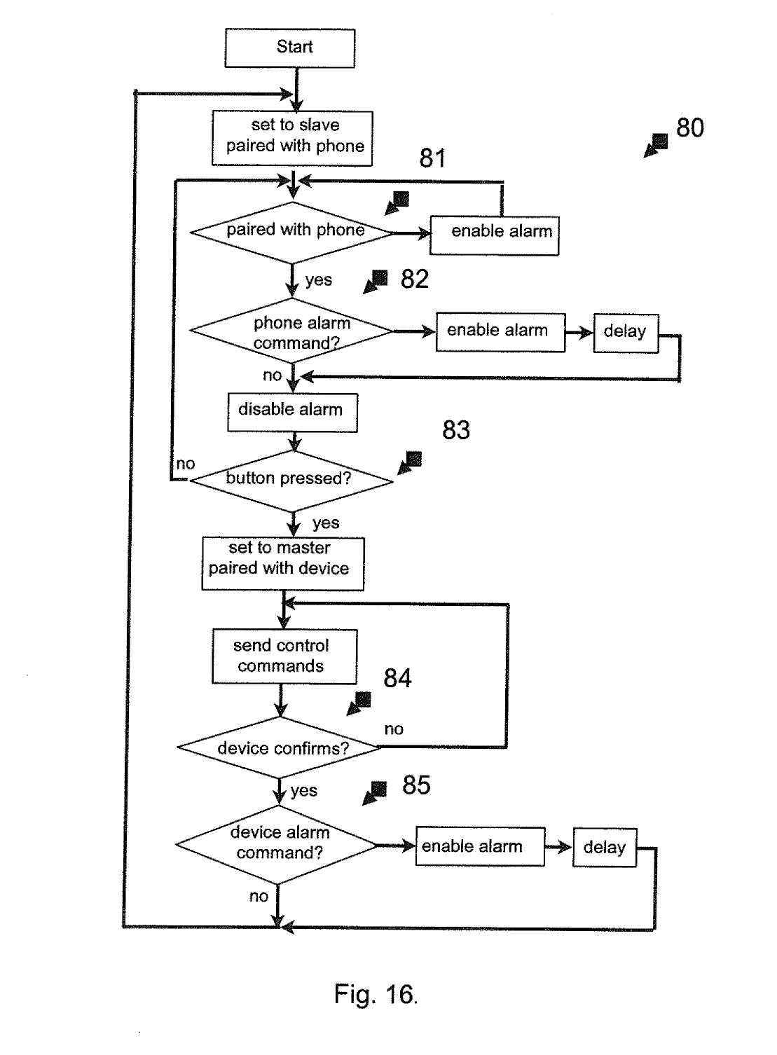

FIG. 16 is an exemplary flowchart 80 depicting an operational sequence for the Intelligent Remote Control Unit (IRCU). An IRCU operates in slave mode when pairing wirelessly with smartphones. It operates in master mode when pairing wirelessly with devices it controls. This wireless connection can be WiFi, Bluetooth, Zigbee, infrared, or other wireless means. An example of this application is a remote controller for an appliance this is discoverable from smartphones or one of devices it controls.

Initially, the IRCU is set to slave mode and paired with a smartphone. When it loses pairing 81 with the smartphone, an alarm is enabled for a period of time. When the IRCU receives an alarm command 82, it enables alarm. After delay, the alarm is disabled. An example of this application is remote controller/key tag. When a key tag is outside of the range of wireless pairing, an alarm is enabled to remind user. An user can press a button to disable the alarm. When an user want to find a loss key chain or handbag, presses an icon on smartphone. The IRCU will transmit alarming signals.

If switch button is pressed (Decision block 83 is Yes) when no alarm, the end user will use this IRCU as a remote controller. It releases pairing with smartphone, set itself to master mode, and begins pairing with devices. Depending on the button pressed, it transmits corresponding control commands to devices. When a device confirms reception 84 of control commands, it checks for any alarm command from devices 85. It enables alarms when an alarm command is received. When used as a remote controller, an user can press a button on one of controlled devices to locate the remote controller.

The foregoing description is illustrative of particular embodiments of the application, but is not meant to be a limitation upon the practice thereof. The following claims, including all equivalents thereof, are intended to define the scope of the application.

1-35. (canceled)

36. A system for controlling an appliance comprising:
one or more normally-closed (NC) switches in electrical communication with the appliance, where the one or more NC switches breaks an electrical current connection with the appliance when pressed and makes the electrical connection when the one or more NC switches is released;
a smart controller in the appliance; and
wherein the smart controller is configured to use the breaks in the electrical current connection to turn off and on the appliance.

37. The system of claim 36, wherein the smart controller further comprises one of: an optical coupling circuit, a diode coupling circuit, a resistor coupling circuit, a capacitor coupling circuit, or a transformer coupling circuit to measure the breaking of electrical current and duration of breaking.

38. The system of claim 37, wherein the smart controller further comprises a master control unit (MCU).

39. The system of claim 38, wherein the MCU further comprises program memories, data memories, a wireless interface, a power measurement circuit, relay circuits to turn on or turn off the appliance, and one or more triac circuits to reduce a supply voltage to the appliance.

40. The system of claim 39, wherein the MCU uses the current breaking event and duration information to perform scripts that control the appliance.

41. The system of claim 39, wherein the scripts are programmed on a smartphone or a computing device and downloaded into the appliance.

42. A system for controlling an appliance comprising:
a smart switch with one or more buttons in electrical communication with the appliance, where the smart switch generates make and break timing signals with a defined specific durations to the appliance;
a smart controller in the appliance; and
wherein the smart controller is configured to use the breaks in the electrical current and the duration of the breaks to control the appliance with the use of one or more relays.

43. The system of claim 44, wherein the smart controller further comprises one of: an optical coupling circuit, a diode coupling circuit, a resistor coupling circuit, a capacitor coupling circuit, or a transformer coupling circuit to measure the breaking of electrical current and duration of breaking.

44. The system of claim 43, wherein the smart controller further comprises a master control unit (MCU).

45. The system of claim 44, wherein the MCU further comprises program memories, data memories, a wireless interface, a power measurement circuit, relay circuits to turn on or turn off the appliance, and one or more triac circuits to reduce a supply voltage to the appliance.

46. The system of claim 45, wherein the MCU uses the current breaking event and duration information to perform scripts that control the appliance.

47. The system of claim 46, wherein the scripts are programmed on a smartphone or a computing device and downloaded into the appliance.

48. A system for controlling an appliance comprising:
a smart switch in electrical communication with the appliance, where the smart switch comprises one or more buttons, a master control unit (MCU), and one or more relay circuits to make and break power to the appliance; and
a smart controller in the appliance;
wherein depending on a button pressed form amongst the one or more buttons, the MCU controls the one or more relay circuits to break and to make an electrical power connection for a predetermined sequence and duration; and
wherein the smart controller is configured to use the breaks in the electrical current and the duration of the breaks to control the appliance.

49. The system of claim 48, wherein the smart controller further comprises one of: an optical coupling circuit, a diode coupling circuit, a resistor coupling circuit, a capacitor coupling circuit, or a transformer coupling circuit to measure the breaking of electrical current and duration of breaking.

50. The system of claim 49, wherein the smart controller further comprises a master control unit (MCU).

51. The system of claim 50, wherein the MCU further comprises program memories, data memories, a wireless interface, a power measurement circuit, relay circuits to turn on or turn off the appliance, and one or more triac circuits to reduce a supply voltage to the appliance.

52. The system of claim 51, wherein the MCU uses the current breaking event and duration information to perform scripts that control the appliance.

53. The system of claim 52, wherein the scripts are programmed on a smartphone or a computing device and downloaded into the appliance.
